(19) United States
(12) Patent Application Publication
(10) Pub. No.: US 2018/0065072 A1
(43) Pub. Date: Mar. 8, 2018

(54) V-BANK FILTER AND METHOD OF MAKING

(71) Applicant: 3M INNOVATIVE PROPERTIES COMPANY, Saint Paul, MN (US)

(72) Inventor: Rajesh K. Katare, Cottage Grove, MN (US)

(21) Appl. No.: 15/559,768

(22) PCT Filed: May 3, 2016
(86) PCT No.: PCT/US16/30545

§ 371 Date: Sep. 19, 2017

Related U.S. Application Data
(60) Provisional application No. 62/160,721, filed on May 13, 2015.

(51) Int. Cl. B01D 46/52; B01D 46/12; B01D 46/00; B01D 39/16

(52) U.S. Cl. CPC B01D 46/522; B01D 39/1623; B01D 46/0001; B01D 46/125

(57) ABSTRACT

A V-bank filter including a first pleated panel and a second pleated panel. The first pleated panel and the second pleated panel are both formed from a single, continuous web of pleated filter material into a V-configuration and the pleats of the first panel are interleaved with the pleats of the second panel at an apex of the V-configuration.

### BACKGROUND

V-bank filters, having at least two filter panels disposed into a “V” configuration, are often used in air filtration systems when a longer service life of the filter is desired since these filters provide for a significantly increased surface area of the filtration media.

### SUMMARY

Typical V-bank filters are constructed by assembling multiple pleated filter panels into alternating V-configurations, and securing them by use of a frame and panels to form a housing. In some of these constructions, end caps are applied over the ends of adjacent pleated filter panels and the pleated filter panels are secured to each other and the end cap by filling the interior portion of the end cap with a hot melt adhesive thereby potting the filter panels to each other and the end cap making an air tight joint. This process can be time consuming, uses large quantities of adhesive, reduces the effective filter area by sealing off part of the airflow path, and be failure prone resulting in unintended air leaks at the joint. Therefore, a new V-bank filter that eliminates the need to join individual filter panels to each other to make a V-bank filter is needed.

The inventors have determined that a single web of filter material can be pleated and formed into a V-bank filter eliminating the step of securing individual filter panels to each other. Since the pleated filter panels are already integrally connected to each other by the continuous web of pleated filter material, the V-bank filters are leak free and eliminate the glue joints of the prior art V-bank filters. Also, since the V-bank filter does not have caps applied over the ends of the filters to join them, airflow through these regions of the filter can occur reducing the pressure drop of the V-bank filter in operation.

Hence in one embodiment, the invention resides in a V-bank filter comprising: a first pleated panel and a second pleated panel; the first pleated panel and the second pleated panel are both formed from a single, continuous web of pleated filter material into a V-configuration, and wherein the pleats of the first panel are interleaved with the pleats of the second panel at an apex of the V-configuration.

In another aspect the invention resides in a V-bank filter comprising: a first pleated panel and a second pleated panel formed into a V-configuration having an open end and an apex; the folds of the first pleated panel and the folds of the second pleated panel both extending in a longitudinal direction from the open end to the apex; and wherein the first pleated panel and the second pleated panel are both formed from a single, continuous web of pleated filter material.

In other aspect the invention resides in a method of making a V-bank filter comprising: folding a filter media to form a primary fold joining a first panel and a second panel; pleating the filter media transversely along the primary fold to form a first pleated panel joined to a second pleated panel by a pleated primary fold; and separating the first pleated panel from the second pleated panel into a V-configuration to form the V-bank filter.

In another aspect the invention resides in a method of making a V-bank filter comprising: pleating a filter media to form three primary folds joining a first panel, a second panel, a third panel, and a fourth panel; pleating the filter media transversely along the three primary folds to form a first pleated panel joined to a second pleated panel, a third pleated panel joined to the second pleated panel, and a fourth pleated panel joined to the third pleated panel by three pleated primary folds; separating the first pleated panel from the second pleated panel into a first V-configuration; and separating the third pleated panel from the fourth pleated paned into a second V-configuration to form the V-bank filter.

### BRIEF DESCRIPTION OF THE DRAWINGS

FIG. 1 illustrates a filter media folded about a primary fold line

FIG. 2 illustrates pleating the filter media transversely along the primary fold line

FIG. 3 illustrates separating the first and second pleated panels into a V-configuration

FIG. 4 illustrates the apex of the filter of FIG. 3, which is inverted and partially cut away.

FIG. 5 illustrates pleating a filter media to from three primary folds

FIG. 6 illustrates pleating the filter media transversely along the primary folds

FIG. 7 illustrates separating the first, second, third, and fourth pleated panels into a first and a second V-configuration

FIG. 8 illustrates an end view of the V-bank filter of FIG. 7 and an end panel

FIG. 9 illustrates two end panels applied to the V-bank filter of FIG. 7

FIG. 10 illustrates a process to make the V-bank filter of FIG. 3.

### DETAILED DESCRIPTION

### Method of Making

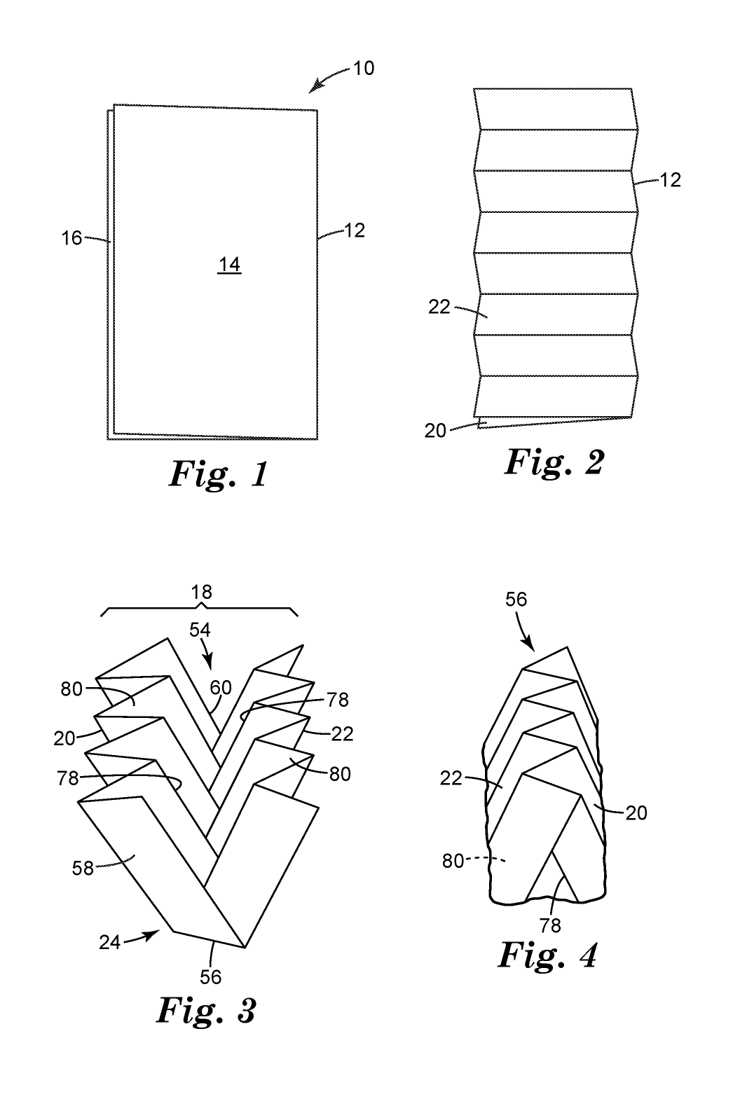

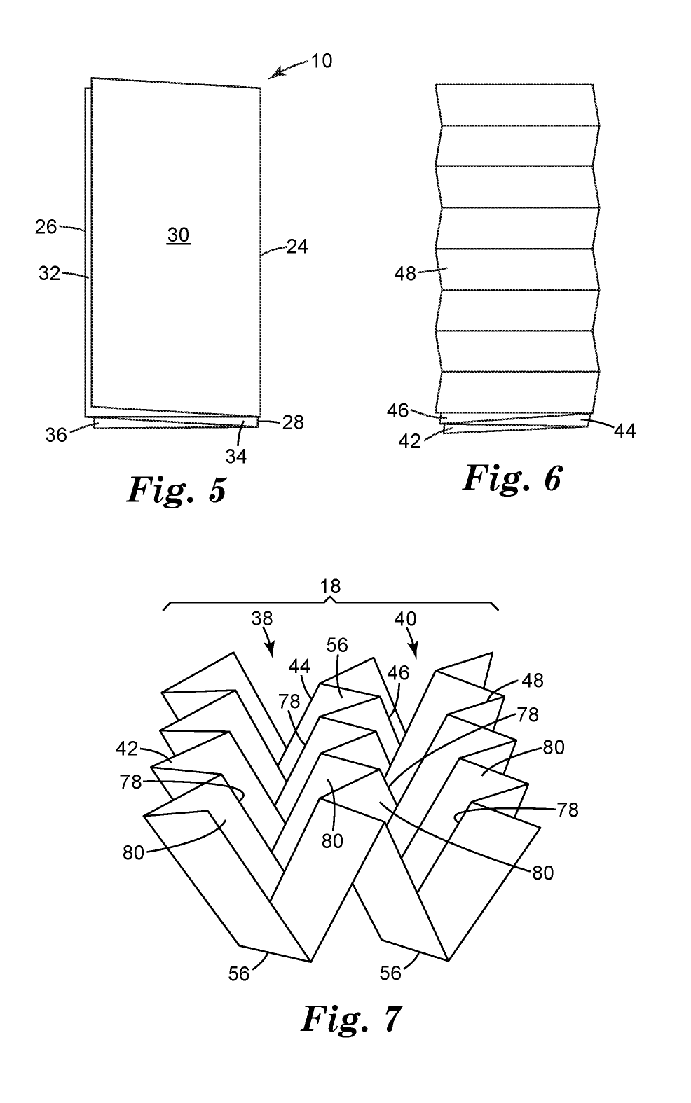

Referring to FIGS. 1-3 a method of making a V-bank filter is illustrated. A sheet or web of filter media 10 is folded to form a primary fold 12 joining a first panel 14 and a second panel 16. Two panels will result in a V-bank filter 18 with two pleated panels (20, 22) arranged into a single V-configuration 24 as seen in FIG. 3. However, the sheet or web of filter media 10 can instead be pleated into 2, 3, 4, 5, or n primary folds resulting in V-bank filters with 3, 4, 5, 6 or n+1 pleated panels. Referring now to FIGS. 5-7 if three primary folds (24, 26, and 28) are used resulting in four panels (30, 32, 34, and 36), a V-bank filter having two V-configurations (38 and 40) and four pleated panels (42, 44, 46, and 48) can be produced. Ordinarily, the primary fold(s) are placed such that each resulting panel has the same overall size, but this is not a requirement and V-bank filters having different sized pleated panels joined together are an additional embodiment.

After making at least one or more primary folds, the filter media is rotated 90 degrees and pleated transversely along the primary fold(s) to form a first pleated panel joined 20 to a second pleated panel 22 by a pleated primary fold as seen in FIG. 2. If additional primary folds and panels are present, they are all pleated at the same time making additional pleated panels joined to each other along the respective pleated primary fold lines as seen in FIG. 6. For clarity, the pleats in FIGS. 3 and 6 are expanded along the machine direction of the web.

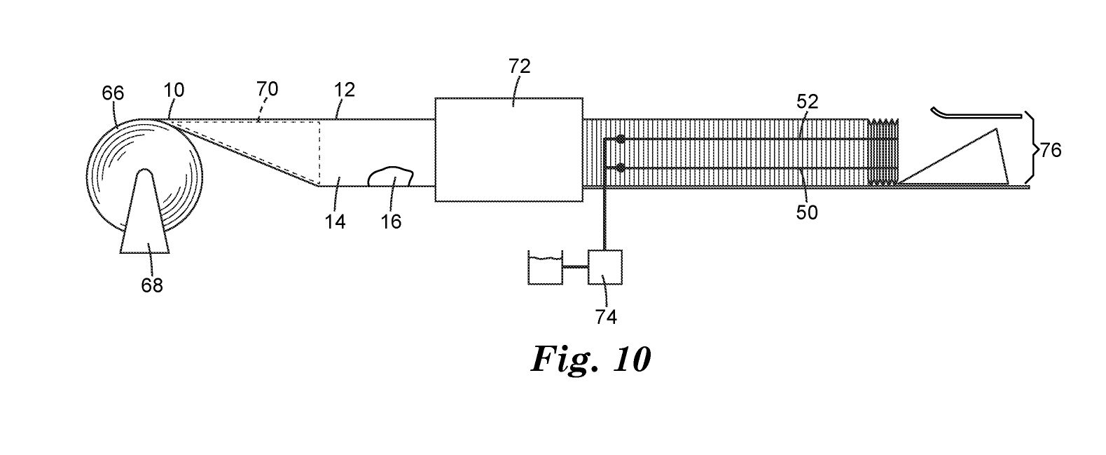

Optionally, after the transverse pleating step and either before or after the separating step, one or more pleat separator strips 50 (FIG. 10) may be applied to the pleated panels. Typically, the pleat separator strips comprise hot melt adhesive applied in one or more lines 52 onto the exterior surfaces of each of the pleated panels. Other adhesives or glue may be used instead of the hot melt adhesive. Alternatively, the pleat separator strip may have a plurality of fingers or projections that are inserted between adjacent pleats to maintain pleat separation.

After the transverse pleating step, the first pleated panel 20 and the second pleated panel 22 are separated into a V-configuration to form the V-bank filter 18 shown in FIG. 3. The separating step can be accomplished by pulling the first and second pleated panels in opposing directions at a location adjacent to the open end 54 that opposes the pleated primary fold line, which will form the apex 56 of the V-configuration. The included angle between the first pleated panel 20 and second pleated panels 22 of the V-bank filter is determined by size, shape, air and pressure drop modeling and is typically in the range from 15 to 45 degrees. If additional pleated panels and pleated primary fold lines are present, typically the separating step starts with an end pair of pleated panels being separated and then progressing to the next pair of pleated panels until all the pleated panels have been separated into one or more V-configurations.

Optionally, once the panels are separated into the V-configuration, a compressive force can be applied to the first side 58 and second side 60 of the V-configuration to “set” the V-shape by creasing the pleated primary fold lines into the opened configuration achieved by the separating step. During the compressive step, a V-shaped jig or fixture having the desired included angle can be used for placing the pleated V-configuration into and then a sliding plate can be urged against one of the pleated filter's ends to set the crease.

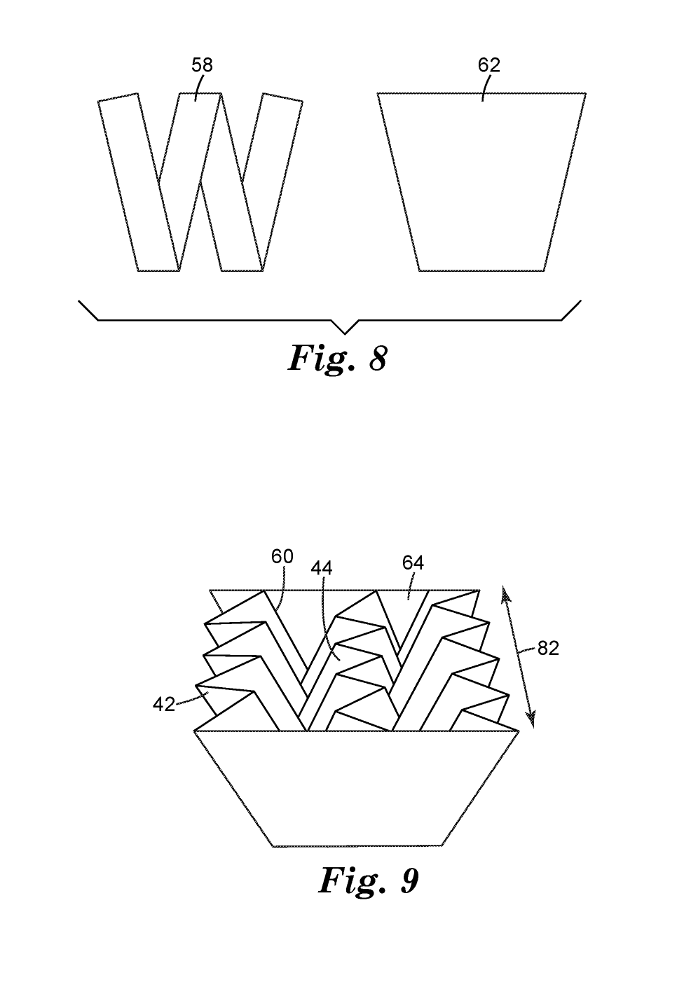

Optionally, as seen in FIGS. 8 and 9, a first side panel 62 can be attached to a first side 58 of V-configuration and a second side panel 64 can be attached to a second side 60 of the V-configuration. The side panels can be made from the same media as the filter media forming the V-bank filter, or may instead be a stiffer or thicker material such as a thermoplastic sheeting, a nonwoven material, or cardboard. The side panels can be attached to the V-configuration by a connection such as adhesive, thermoplastic welding, ultra-sonic bonding, crimping, staples, pins or clips.

Optionally, the V-configuration can be disposed into a suitable a suitable frame such as a traditional V-bank filter frame known to those of skill in the art or into a simple rectangular frame surrounding only the upper portion of the V-bank configuration such as may be used to frame posters or photographs. The V-bank configuration can be secured to a simple rectangular frame and held within the frame using either adhesives or mechanical means. V-bank filters can also be framed using combinations of extruded or molded parts that support the open end 54, the apex end 56 and the sides (58, 60) to provide further rigid support. These filter frames are generally made of thermoplastics and discarded with rest of the V-bank filter but the V-bank filter can also be used with permanent or reusable frames made from more durable materials such as metal.

Referring now to FIG. 10, a continuous process for making the V-shape filter 18 of FIG. 3 is illustrated. The process includes unwinding a roll 66 of filter media 10 on an unwind 68 and directing the filter media 10 over a folding board 70 to fold it in half forming the first panel 14 and the second panel 16 joined by the primary fold line 12. The folded web is then directed into a pleater 72 for transversely pleating the first and second panels along the primary fold line. Suitable pleaters are known to those of skill in the art. In one embodiment, a blade pleater was used. After exiting the pleater, a glue applicator 74 applies two pleat separator strips (50, 52) to each side of the pleated web exiting the pleater 72. The pleat separator strips help to maintain the integrity of the pleated web during the separating step. After the glue has hardened, the web is run through a pleat separator 76. The pleat separator 76 can be another folding board or shoe with an upper retainer to force the pleated panels into the shoe that instead of folding the web onto itself opens the web up to the desired included angle between the first and the second pleated panels. Discrete lengths of the pleated panels can be cut from the pleated web either before or after the pleat separator 76. Thereafter, end panels (62 and 64) can be attached to maintain the opened configuration of the V-bank filter. Further converting processes can be used to place the V-bank filter into a suitable frame or to join a single V-bank filter to one or more other V-bank filters as needed.

### Continuous V-Bank Filter

Referring now to FIG. 3, a V-bank filter 18 is shown formed from a single continuous web of pleated filter material. The V-bank filter includes a first pleated panel 20 and a second pleated panel 22. The first pleated panel and the second pleated panel are both formed from a single, continuous web of pleated filter material into a V-configuration. The pleats of the first panel are interleaved with the pleats of the second panel at an apex 56 of the V-configuration opposite an open end 54 of the V-configuration. In use, air is urged into the open end(s) 54 of the V-configuration and flows through the pleated panels (20, 22), which are integrally joined at the apex 56. As best seen in FIG. 3, since an end cap is not applied at the apex 56 to join the adjacent filter panels to each other, air can also flow through the apex 56 of the V-configuration increasing the effective filter area and reducing the pressure drop of the V-bank filter during use.

Referring now to FIG. 4, the apex 56 of the V-configuration is illustrated. Since the primary fold line(s) have been transversely pleated as described above, the apex 56 is fully pleated as well. As seen, a plurality of crowns 78 of the first pleated panel 20 are partially disposed within a plurality of valleys 80 of the second pleated panel 22 at the apex 56 thereby interleaving the two pleated panels at the apex. In a similar manner, a plurality of crowns 78 of the second pleated panel 22 are partially disposed within a plurality of valleys 80 of the first pleated panel 20 at the apex. If additional pleated panels are present, they are interleaved in a like manner as shown in FIG. 7

When more than two pleated panels are present, additional apexes are present after the separating step where the multiple pleated panels are integrally joined to each other and interleaved. For example, if the filter media is pleated into three primary fold lines, transversely pleated along the three primary fold lines into four pleated filter panels, and separated into a V-bank filter having two V-configurations similar in appearance to the letter W, then the resulting V-bank filter will have three apexes where adjacent filter panels are integrally joined and interleaved with each other as seen in FIGS. 5-7. As such a V-bank filter having a first pleated panel 42, a second pleated panel 44, a third pleated panel 46 and a fourth pleated panel 48 all formed from a single, continuous web of pleated filter material into a first V-configuration 38 and a second V-configuration 40 will be produced. The pleats of the first panel 42 are interleaved with the pleats of the second panel 44 at an apex 56 of the first V-configuration 38, the pleats of the second panel 44 are interleaved with the pleats of the third panel 46 at an apex 56 adjacent an open end of the first V-configuration 38 and the pleats of the third panel 46 are interleaved with the pleats of the fourth panel 48 at an apex 56 of the second V-configuration 40.

Referring back to FIG. 3, the primary folds and transverse pleating process results in a V-bank filter with good structural support. As seen, the V-bank filter 18 includes a first pleated panel 20 and a second pleated panel 22 formed into a V-configuration having an open end 54 and an apex 56. The folds of the first pleated panel 20 and the folds of the second pleated panel 22 both extend in a longitudinal direction from the open end 54 to the apex 56, and the first pleated panel 20 and the second pleated panel 22 are both formed from a single, continuous web of pleated filter material. Since the folds of the first and second pleated panels extend in the longitudinal direction and are interleaved and pleated at each apex, the structure is fairly self-supporting and able to resist the air forces in use and not blowout or unduly billow. If additional pleated panels are present when using more than one primary fold, the additional panels are integrally connected and interleaved at the apexes with the folds of the pleated panels extending in a longitudinal direction from the open end to the apex as seen in FIG. 7.

The filter media can be any suitable media employed for air filtration. Typically the filter media has suitable stiffness to maintain the pleated configuration during the pleated panel separating process and when subjected to air flow in use. Multilayer filter media can be used with one layer optimized for filtration and a second layer having a stiffness optimized for pleating. Suitable filter media for various air or liquid applications is known to those of skill in the art and can be selected depending on the expected contaminants loading and the specific filtering application intended. In one specific embodiment, the filter media comprised of electrically charged polypropylene blown melt fibers (BMF) 40 gsm (grams per square meter) laminated to a support polyester scrim of 90 gsm weight.

Referring back to FIGS. 8 and 9 optional side panels (62, 64) are shown. A first side panel 62 joining the first pleated panel 42 to the second pleated panel 44 on a first side 58 and a second side panel 64 joining the first pleated panel 44 to the second pleated panel 44 on a second side is shown 60. If additional pleated panels are present (multiple V-configurations), the side panels can be joined to them as well. The side panels can be used to hold the V-bank filter into a specific orientation such as an overall length with the desired included angle set between adjacent filter panels. Once the side panels are attached a “stand alone” V-bank filter assembly is completed. The assembly with the side panels can be used “as is” in a suitable housing or the assembly can be placed into a frame. Suitable materials for the side panels include a filtration media, a single or multi-layer thermoplastic and nonwoven webs.

Suitable methods for joining the side panels to the V-bank filter include adhesive, thermoplastic welding, ultra-sonic bonding, crimping, staples, pins and clips

One advantage to the pleated V-bank filter with attached side panels is the configuration is partially collapsible for shipping or can be expanded to fit housings of slightly different lengths. This can reduce shipping costs or enable the V-Bank filter to fit more than a single size of housing. Since the apexes of each V-configuration are fully pleated without epoxy potted end caps joining the adjacent pleated panels together, the entire V-bank filter assembly can be expanded or collapsed in the transverse direction 82 (FIG. 9) by simply expanding or collapsing the longitudinal pleats when moving the end panels either closer together or farther apart.

### Example

In one embodiment, a 40 gsm polypropylene blown melt fiber media manufactured at 3M Company's Aberdeen, S. Dak., plant was laminated, using a hot glue spray laminator to a spun bond polyester scrim (90 gsm, Johns Manville, Denver, Colo.). This two layer media was electret charged to improve filtration efficiency.

The charged, laminated media of 24 inch (61 cm) width was then folded over once using a lab fixture and fed into a lab scale blade type pleater to create 1 inch (2.5 cm) pleat widths in the transverse direction. The blade pleater was equipped with 3 blades, a heating zone and a pressure zone to create pleat packs. Once 92 pleats were formed, the pleated media pack was removed from the pleater and placed onto a table.

Pleats were separated using plastic combs with teeth separations of 5.75 mm, then 2 glue bead lines were placed on each pleated filter panel using a hot glue gun, to retain the pleat separation. Once glue beads were solidified, the two pleated panels were carefully separated, starting from one end, all the way to the other end of the pleat pack. The pleated panels were kept separated using a lab fixture such that they had an included angle of 26 degrees while a hot air gun was used to relax the stress at the pleated apex caused by the separation. Four individual V-configurations similar to FIG. 3 were attached together using three hotmelt adhesive potted end caps spanning the adjacent pleated panels at the open end where the four V-configurations needed to be joined to each other. The four bank V-bank filter was adhered using a hot melt adhesive to a molded polystyrene frame used with commercially available V-bank filters such as 3M™ Commercial HVAC Filter MERV A14 V-Bank with Gasket, Standard Flow, Model 733, 24 in×24 in×12 in, 1 per case available from 3M Company.

What is claimed is:

1. A V-bank filter comprising:
a first pleated panel and a second pleated panel;
the first pleated panel and the second pleated panel are both formed from a single, continuous web of pleated filter material into a V-configuration, and
wherein the pleats of the first panel are interleaved with the pleats of the second panel at an apex of the V-configuration.

2. The V-bank filter of claim 1 wherein a plurality of crowns of the first pleated panel are partially disposed within a plurality of valleys of the second pleated panel at the apex.

3. The V-bank filter of claim 2 comprising a first side panel joining the first pleated panel to the second pleated panel on a first side and a second side panel joining the first pleated panel to the second pleated panel on a second side.

4. The V-bank filter of claim 3 comprising a frame surrounding an open end of the V-configuration.

5. The V-bank filter of claim 1 comprising:
the first pleated panel, the second pleated panel, a third pleated panel and a fourth pleated panel all formed from a single, continuous web of pleated filter material into a first V-configuration and a second V-configuration; and
wherein the pleats of the first panel are interleaved with the pleats of the second panel at an apex of the first V-configuration, the pleats of the second panel are interleaved with the pleats of the third panel adjacent an open end of the first V-configuration and the pleats of the third panel are interleaved with the pleats of the fourth panel at an apex of the second V-configuration.

6. The V-bank filter of claim 5 wherein a plurality of crowns of the first pleated panel are partially disposed within a plurality of valleys of the second pleated panel at the apex of the first V-configuration and a plurality of crowns of the third pleated panel are partially disposed within a plurality of valleys of the fourth pleated panel at the apex of the second V-configuration.

7. The V-bank filter of claim 6 comprising a first side panel joining the first pleated panel, the second pleated panel, the third pleated panel, and the fourth pleated panel on a first side; and a second side panel joining the first pleated panel, the second pleated panel, the third pleated panel, and the fourth pleated panel on a second side.

8. The V-bank filter of claim 7 comprising a frame surrounding the first and the second V-configurations.

9. The V-bank filter of claim 1 wherein an end cap is not adhered to the apex and the apex remains permeable to air.

10. A V-bank filter comprising:
a first pleated panel and a second pleated panel formed into a V-configuration having an open end and an apex;
the folds of the first pleated panel and the folds of the second pleated panel both extending in a longitudinal direction from the open end to the apex; and
wherein the first pleated panel and the second pleated panel are both formed from a single, continuous web of pleated filter material.

11. The V-bank filter of claim 10 wherein the pleats of the first panel are interleaved with the pleats of the second panel at the apex.

12. The V-bank filter of claim 11 wherein a plurality of crowns of the first pleated panel are partially disposed within a plurality of valleys of the second pleated panel at the apex.

13. The V-bank filter of claim 12 comprising a first side panel joining the first pleated panel to the second pleated panel on a first side and a second side panel joining the first pleated panel to the second pleated panel on a second side.

14. The V-bank filter of claim 13 comprising a frame surrounding the open end.

15. The V-bank filter of claim 10 comprising:
the first pleated panel and the second pleated panel formed into a first V-configuration having an open end and an apex;
a third pleated panel and a fourth pleated panel formed into a second V-configuration having an open end and an apex;
the folds of the first pleated panel and the folds of the second pleated panel extending in a longitudinal direction from the open end to the apex of the first V-configuration;
the folds of the third pleated panel and the folds of the fourth pleated panel extending in a longitudinal direction from the open end to the apex of the second V-configuration; and
wherein the first pleated panel, the second pleated panel, the third pleated panel, and the fourth pleated panel are all formed from a single, continuous web of pleated filter material.

16. The V-bank filter of claim 15 wherein the pleats of the first panel are interleaved with the pleats of the second panel at the apex of the first V-configuration, and the pleats of the third panel are interleaved with the pleats of the fourth panel at the apex of the second V-configuration.

17. The V-bank filter of claim 16 wherein a plurality of crowns of the first pleated panel are partially disposed within a plurality of valleys of the second pleated panel at the apex of the first V-configuration, and a plurality of crowns of the third pleated panel are partially disposed within a plurality of valleys of the fourth pleated panel at the apex of the second V-configuration.

18. The V-bank filter of claim 17 comprising a first side panel joining the first pleated panel, the second pleated panel, the third pleated panel and the fourth pleated panel on a first side; and a second side panel joining the first pleated panel, the second pleated panel, the third pleated panel and the fourth pleated panel on a second side.

19. The V-bank filter of claim 18 comprising a frame surrounding the open ends of the first and the second V-configurations.

20. A method of making a V-bank filter comprising:
folding a filter media to form a primary fold joining a first panel and a second panel;
pleating the filter media transversely along the primary fold to form a first pleated panel joined to a second pleated panel by a pleated primary fold; and
separating the first pleated panel from the second pleated panel into a V-configuration to form the V-bank filter.

21. The method of claim 1 comprising attaching a first side panel to a first side of V-configuration and attaching a second side panel to a second side of the V-configuration.

22. The method of claim 21 comprising disposing the V-bank filter into a frame.

23. A method of making a V-bank filter comprising:
pleating a filter media to form three primary folds joining a first panel, a second panel, a third panel, and a fourth panel;
pleating the filter media transversely along the three primary folds to form a first pleated panel joined to a second pleated panel, a third pleated panel joined to the second pleated panel, and a fourth pleated panel joined to the third pleated panel by three pleated primary folds;
separating the first pleated panel from the second pleated panel into a first V-configuration; and
separating the third pleated panel from the fourth pleated paned into a second V-configuration to form the V-bank filter.

24. The method of claim 23 comprising attaching a first side panel to a first side of the first and second V-configurations and attaching a second side panel to a second side of the first and second V-configurations.

25. The method of claim 24 comprising disposing the V-bank filter into a frame.
